(19) United States
(12) Patent Application Publication
(10) Pub. No.: US 2021/0155202 A1
(43) Pub. Date: May 27, 2021

(54) AUTHORIZED VEHICLE ACCESS

(71) Applicant: Ford Global Technologies, LLC, Dearborn, MI (US)

(72) Inventors: Cameron Smyth, Wyandotte, MI (US); Ali Hassani, Ann Arbor, MI (US); John Robert Van Wiemeersch, Novi, MI (US); Lawrence Chikeziri Amadi, Chicago, IL (US)

(73) Assignee: Ford Global Technologies, LLC, Dearborn, MI (US)

(21) Appl. No.: 16/690,183

(22) Filed: Nov. 21, 2019

(51) Int. Cl. B60R 25/24; B60R 25/20; B60R 25/23; G06N 20/00

(52) U.S. Cl. CPC B60R 25/241; G06N 20/00; B60R 25/23; B60R 25/2009

(57) ABSTRACT

A validity of a user input is determined by determining the user input (a) matches an identifier string and is valid or (b) does not match the identifier string and is invalid. Access to a vehicle is authorized based on the user input being valid. A number of invalid attempts are determined based on the user input being invalid. Based on the number of invalid attempts being less than a lockout number, a risk level of the user input is evaluated to adjust the lockout number. Then, upon determining the validity of a secondary user input, (a) access to the vehicle is authorized based on the secondary user input being valid or (b) a lockout of the vehicle is activated based on the secondary user input being invalid and the number of invalid attempts equaling the adjusted lockout number.

### BACKGROUND

Various mechanisms can be provided to allow a user to access and operate a vehicle. For example, where the vehicle is a multi-user vehicle, e.g., a vehicle to which a particular user may be provided temporary or one-time access, the user could be provided with a physical key, an electronic fob, etc., to allow the user to access and operate the vehicle. An authorized user might also be provided with means for electronic authentication, e.g., a password or PIN (personal identification number) that could be input via an interface provided on the vehicle. However, there presently are shortcomings with electronic authentication.

### BRIEF DESCRIPTION OF THE DRAWINGS

FIG. 1 is a block diagram illustrating an example authentication system for a vehicle.

FIG. 2 is a flowchart of an exemplary process for authenticating access to the vehicle.

FIG. 3 is a flowchart of an exemplary process for activating a temporary identifier string, in this example, a temporary personal identification number (PIN).

### DETAILED DESCRIPTION

A system includes a computer including a processor and a memory, the memory storing instructions executable by the processor determine a validity of a user input by determining the user input (a) matches an identifier string and is valid or (b) does not match the identifier string and is invalid. The instructions further include instructions to authorize access to a vehicle based on the user input being valid. The instructions further include instructions to determine a number of invalid attempts based on the user input being invalid. The instructions further include instructions to, based on the number of invalid attempts being less than a lockout number, evaluate a risk level of the user input to adjust the lockout number. The instructions further include instructions to then, upon determining the validity of a secondary user input, (a) authorize access to the vehicle based on the secondary user input being valid or (b) activate a lockout of the vehicle based on the secondary user input being invalid and the number of invalid attempts equaling the adjusted lockout number.

The instructions can further include instructions to decrease the lockout number based on the risk level being above a threshold.

The instructions can further include instructions to increase the lockout number based on the risk level being below a threshold.

The instructions can further include instructions to determine the risk level based on comparing behavioral data from the user providing the invalid user input to stored behavioral data. Behavioral data can include at least one of an offset error, an input speed, an input time, and a location of the vehicle.

Evaluating the risk level can include obtaining the risk level as output from a machine learning program.

Behavioral data from the user providing the invalid user input and stored behavioral data can be input into the machine learning program. Behavioral data can include at least one of an offset error, an input speed, an input time, and a location of the vehicle.

The instructions can further include instructions to output a message to a master device upon the number of invalid attempts equaling the adjusted lockout number.

The instructions can further include instructions to authorize access to the vehicle based on a message from a master device.

The instructions can further include instructions to receive a temporary identifier string from a server. The server may be programmed to generate the temporary identifier string and transmit the temporary identifier string to the computer.

The instructions can further include instructions to, upon activation of the temporary identifier string, authorize access to the vehicle based on the user input matching the temporary identifier string.

The instructions can further include instructions to activate the temporary identifier string based on a message from a master device.

The instructions can further include instructions to activate the temporary identifier string for a time period.

A method includes determining a validity of a user input by determining the user input (a) matches an identifier string and is valid or (b) does not match the identifier string and is invalid. The method further includes authorizing access to a vehicle based on the user input being valid. The method further includes determining a number of invalid attempts based on the user input being invalid. The method further includes, based on the number of invalid attempts being less than a lockout number, evaluating a risk level of the user input to adjust the lockout number. The method further includes then, upon determining the validity of a secondary user input, (a) authorizing access to the vehicle based on the secondary user input being valid or (b) activate a lockout of the vehicle based on the secondary user input being invalid and the number of invalid attempts equaling the adjusted lockout number.

The method can further include decreasing the lockout number based on the risk level being above a threshold and increasing the lockout number based on the risk level being below the threshold.

The method can further include determining the risk level based on comparing behavioral data from the user providing the invalid user input to stored behavioral data. Behavioral data can include at least one of an offset error, an input speed, an input time, and a location of the vehicle

The method can further include outputting a message to a master device upon the number of invalid attempts equaling the adjusted lockout number.

Evaluating the risk level can include obtaining the risk level as output from a machine learning program.

Behavioral data from the user providing the invalid user input and stored behavioral data can be input into the machine learning program. Behavioral data can include at least one of an offset error, an input speed, an input time, and a location of the vehicle.

The method can further include generating, in a server, a temporary identifier string. The method can further include transmitting the temporary identifier string to a computer. The method can further include receiving, in the computer, the temporary identifier string from the server. The method can further include, upon activation of the temporary identifier string, authorizing access to the vehicle based on the user input matching the temporary identifier string.

The method can further include activating the temporary identifier string based on a message from a master device.

Further disclosed herein is a computing device programmed to execute any of the above method steps. Yet further disclosed herein is a computer program product, including a computer readable medium storing instructions executable by a computer processor, to execute an of the above method steps.

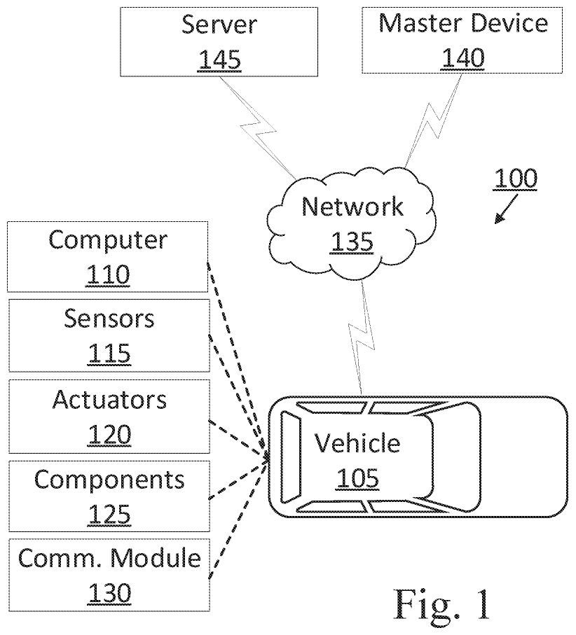

FIG. 1 is a block diagram illustrating an example authentication system 100 for a vehicle 105. The vehicle 105 includes a vehicle computer 110 programmed to determine a validity of a user input by determining the user input (a) matches an identifier string and is valid or (b) does not match the identifier string and is invalid. The vehicle computer 110 is further programmed to authorize access to a vehicle based on the user input being valid. The vehicle computer 110 is further programmed to determine a number of invalid attempts based on the user input being invalid. The vehicle computer 110 is further programmed to, based on the number of invalid attempts being less than a lockout number, evaluate a risk level of the user input to adjust the lockout number. The vehicle computer 110 is further programmed to then, upon determining the validity of a secondary user input, (a) authorize access to the vehicle based on the secondary user input being valid or (b) activate a lockout of the vehicle based on the secondary user input being invalid and the number of invalid attempts equaling the adjusted lockout number.

The vehicle computer 110 can prevent an unauthorized user from accessing and/or operating the vehicle 105. For example, the vehicle computer 110 can store an identifier string such as a personal identification number (PIN), e.g., in a memory. Upon receiving a user input, the vehicle computer 110 can then authorize or deny a user access to the vehicle 105 based on the user input being valid or invalid, respectively. Additionally, the vehicle computer 110 can prevent access to the vehicle 105 based on receiving a number of invalid user inputs equaling a lockout number, as discussed below. Advantageously, the vehicle computer 110 can determine a risk level of an invalid user input and can adjust the lockout number based on the risk level, which can provide fewer attempts for an unauthorized user to guess the identifier string and obtain access to the vehicle 105.

The vehicle 105 includes a vehicle computer 110, sensors 115, actuators 120, vehicle components 125, and a vehicle communications module 130. The communications module 130 allows the vehicle computer 110 to communicate with one or more infrastructure elements 140 and the computer 150, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein.

The vehicle computer 110 may operate the vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicles 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, etc., as well as to determine whether and when the vehicle computer 110, as opposed to a human operator, is to control such operations. Additionally, the vehicle computer 110 may be programmed to determine whether and when a human operator is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle communications network, the vehicle computer 110 may transmit messages to various devices in the vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles 105, etc., relative to the location of the vehicle 105. The sensors 115 may further, alternatively or additionally, for example, include camera sensor(s) 115, e.g. front view, side view, etc., providing images from an area surrounding the vehicle 105. In the context of this disclosure, an object is a physical, i.e., material, item that can be represented by physical phenomena (e.g., light or other electromagnetic waves, or sound, etc.) detectable by sensors 115. Thus, vehicles 105, as well as other items including as discussed below, fall within the definition of “object” herein.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, one or more restraint systems (e.g., airbags, seatbelts, etc.), a movable seat, etc.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications to another vehicle, and/or to other computers (typically via direct radio frequency communications). The communications module 130 could include one or more mechanisms by which the computers 110 of vehicles 105 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth®, IEEE 802.11, dedicated short range communications (DSRC), and/or wide area networks (WAN), including the Internet, providing data communication services.

The network 135 represents one or more mechanisms by which a vehicle computer 110 may communicate with remote computers, e.g., a master device 140, a server 145, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, Ultra-Wide Band (UWB), vehicle-to-vehicle (V2V) such as Dedicated Short Range Communications (DSRC), etc.), local area networks (LAN) and/or wide area networks (WAN), including the Internet, providing data communication services.

The master device 140 can be a conventional computing device, i.e., including one or more processors and one or more memories, programmed to provide operations such as disclosed herein. The master device 140 may be a portable device. A portable device is any one of a variety of computers that can be used while carried by a person, e.g., a smartphone, a tablet, a personal digital assistant, a key fob, a smart watch, etc. The master device 140 typically includes one or more elements for providing output to a user, e.g., a display and/or a speaker, and one or more elements for receiving an input, e.g., a touchscreen display, a keyboard, a microphone, a camera, etc. The master device 140 may be maintained by an authorized user, e.g., a vehicle 105 owner. The master device 140 may include an identifier that identifies the master device 140. In this context, an “identifier” is an alphanumeric string of data that corresponds to the master device 140. That is, the identifier identifies the specific master device 140.

The master device 140 receives an input from the authorized user, e.g., the vehicle 105 owner. The input may, for example, specify an identifier string such as a PIN or the like that authorizes access to the vehicle 105. That is, the authorized user, e.g., the vehicle 105 owner, specifies the identifier string. An identifier string, e.g., a PIN, is a string of data, e.g., an alphanumeric string, a numeric string, etc. In such an example, the master device 140 can store the identifier string, e.g., in a memory of the master device 140. Additionally, the master device 140 transmits the input, e.g., a PIN, to the vehicle computer 110, e.g., via the network 135. As another example, the input can authorize access to the vehicle 105, as discussed below.

The server 145 can be a conventional computing device, i.e., including one or more processors and one or more memories, programmed to provide operations such as disclosed herein. Alternatively, the server 145 may be a cloud-based server. Further, the server 145 can be accessed via the network 135, e.g., the Internet or some other wide area network. The server 145 may be programmed to generate a temporary identifier string, e.g., using a conventional random or pseudorandom number generator program such as a FIPS 186-4 standard algorithm, a NIST SP 800-90 A algorithm, a stream cipher, a Yarrow algorithm, a Fortuna algorithm, an ANSI X9.17 standard algorithm, etc. The server 145 can then transmit the temporary identifier string to the vehicle computer 110. The server 145 may update the temporary identifier string, i.e., generate a new temporary identifier string, based on e.g., activation of the temporary identifier string, the vehicle computer 110 authorizing access to the vehicle 105 based on the temporary identifier string, determining the vehicle 105 arrived at a destination (e.g., based on sensor 115 data received from the vehicle computer 110), a request from the master device 140, etc.

The vehicle computer 110 is programmed to receive a user input, e.g., via an interface on the vehicle 105. The interface may be, for example, a keypad. The interface may be on the vehicle 105 at any suitable location, e.g., adjacent a door handle. A user input in this context is a string of characters specified by a user, e.g., via the interface. The vehicle computer 110 can identify a last character of the string of the user input based on, e.g., the user selecting an “enter” key or the like, a number of characters in the string of the user input equaling a predetermined number, a circular buffer (e.g., upon receiving a string of the user input, comparing a number of characters in the string of the user input to a number of characters in the strings of a fixed number, e.g., five, of previously received user inputs), etc. In addition to the user input, the vehicle computer 110 may receive image data, e.g., via an image sensor 115 such as an optical digital camera, of the user providing the user input. The image sensor 115 may, for example, capture the image data based on detecting the user within a distance of the vehicle 105, e.g., the interface.

The vehicle computer 110 is programmed to determine a validity of the user input. For example, the vehicle computer 110 can compare the user input to the identifier string. The vehicle computer 110 can, for example, receive the identifier string from the master device 140, e.g., via the network 135, and store the identifier string, e.g., in a memory of the vehicle computer 110. For example, the vehicle computer 110 can determine the user input matches the identifier string based on each character of the user input being the same as the corresponding character of the identifier string. As another example, the vehicle computer 110 can input the user input and the identifier string to a cryptographic algorithm, such as a hashing function, an encryption function, a Password Based Key Derivation Function (PBKDF), etc., and receive a first output and a second output, respectively. In such an example, the vehicle computer 110 can then determine the user input matches the identifier string based on the first output matching the second output. In the case that the user input matches the identifier string, the vehicle computer 110 determines the user input is valid. In the case that the user input does not match the identifier string, the vehicle computer 110 determines the user input is invalid.

The vehicle computer 110 is programmed to authorize access to the vehicle 105 based on the user input being valid. For example, the vehicle computer 110 can actuate one or more vehicle components 125, e.g., doors, locks, windows, etc., to allow the user physical access to the vehicle 105 based on the user input being valid. As another example, the vehicle computer 110 can authorize the user to operate the vehicle 105 based on the user input being valid.

The vehicle computer 110 is programmed to record a number of invalid user inputs. That is, upon determining the user input is invalid, the vehicle computer 110 count that instance of an invalid user input. For example, the vehicle computer 110 may store the number of invalid user inputs in a memory. The vehicle computer 110 increases the number of invalid user inputs, e.g., by one, upon each instance of determining a user input is invalid. The vehicle computer 110 typically records the number of invalid user inputs that are consecutive. That is, the vehicle computer 110 resets the number of invalid user input to zero upon determining a user input is valid. The vehicle computer 110 then determines and stores, e.g., in a memory, behavioral data from the user providing the invalid user inputs. As used herein, “behavioral data” is data, derived from a measurement or measurements of one or more physical characteristics or states of a user that indicates characteristics related to a pattern of behavior of the user providing the user input. Behavioral data includes at least one of an offset error, an input duration, an input time, and an input location.

An offset error is a number specifying differences between characters of the user input and corresponding characters of the identifier string. The vehicle computer 110 can determine the offset error based on comparing the user input to the identifier string to determine the offset error. For example, the offset error may be determined based on a Hamming distance. A Hamming distance of two strings of data is a number of positions at which corresponding characters are different. For example, the Hamming distance of “1234” and “1237” is one (i.e., the fourth characters are different). As another example, the Hamming distance between “1234” and “1432” is two (i.e., the second and fourth characters are different).

Additionally, or alternatively, the offset error may be determined based on a sum of Manhattan distances of corresponding characters in the user input and the identifier string. A Manhattan distance is a sum of the absolute differences of Cartesian coordinates of corresponding characters of the user input and the identifier string. In such an example, the interface may be a three-by-three numerical keypad (e.g., a bottom row including keys corresponding to characters 1-3, a middle row including keys corresponding to characters 4-6, and a top row including keys corresponding to characters 7-9). The vehicle computer 110 can determine Cartesian coordinates (x, y) of each key based on a coordinate system having an origin at the interface. For example, with the origin at the key corresponding to “5,” the key corresponding to “1” on the interface may have Cartesian coordinates (−1, −1), and the key corresponding to “9” may have Cartesian coordinates (1, 1). In such an example, the Manhattan distance between “1” and “9” is four. In these circumstances, the vehicle computer 110 can determine the Manhattan distance of each character of the user input relative to the identifier string. Upon determining the Manhattan distance for each character in the user input, the vehicle computer 110 can sum the Manhattan distance for each character to determine the offset error. As another example, the offset error may be determined based on a sum of the absolute differences of corresponding characters between the user input and the identifier string. For example, the offset error of “1234” and “2341” is six.

An input duration is the amount of time, e.g., milliseconds, seconds, etc., from input of the first character to input of the last character of the user input. The vehicle computer 110 may determine the last character of the user input based on the number of characters of the identifier string. For example, the last character is the fourth character input in the case that the identifier string is four characters. The vehicle computer 110 may, for example, start a timer upon receiving user input of a first character and stop the timer upon receiving user input of a last character. The vehicle computer 110 may then record an elapsed time of the timer.

An input time is a time of day, e.g., 7:54 am, 2:16 pm, etc., that the user input is provided to the vehicle computer 110. That is, the vehicle computer 110 may record the time of day upon receiving a user input. An input location is a location of the vehicle 105 when the user input is provided to the vehicle computer 110. That is, the vehicle computer 110 may record the location of the vehicle 105 upon receiving a user input. Location data may be in a known form, e.g., geo-coordinates such as latitude and longitude coordinates obtained via a navigation system, as is known, that uses the Global Positioning System (GPS).

The vehicle computer 110 is programmed to store, e.g., in a memory, a lockout number. The lockout number is an integer. The vehicle computer 110 is programmed to compare the number of invalid user inputs to the lockout number. In the case that the number of invalid user inputs is below the lockout number, the vehicle computer 110 continues to accept additional user inputs and authorize access to the vehicle 105 based on a valid user input. Conversely, in the case that the number of invalid user inputs equals the lockout number, the vehicle computer 110 activates a lockout. During a lockout, the vehicle computer 110 prevents access to the vehicle 105, e.g., the vehicle computer 110 may maintain actuation of one or more vehicle components 125 such as doors, door locks, etc., and blocks transmission of additional user inputs. In these circumstances, the vehicle computer 110 may be programmed to transmit a message to the master device 140 indicating activation of the lockout. Additionally, or alternatively, the vehicle computer 110 can transmit image data of the user, e.g., obtained via an image sensor 115 on the vehicle 105, providing the user input, e.g., in a same or separate transmission as the message. The vehicle computer 110 may deactivate the lockout based on, e.g., a predetermined amount of time, a message from the master device 140 (as discussed below), a message from the server 145, etc.

The vehicle computer 110 is programmed to determine a risk level of an invalid user input. As used herein, a “risk level” is a number, typically a scalar value between 0 and 1, or a percentage, that the vehicle computer 110 can use to determine whether a user providing the user input is authorized or unauthorized. The risk level indicates the difference between the behavioral data from the user providing the invalid user input and the stored behavioral data from an authorized user. For example, the vehicle computer 110 may determine the risk level according to Equation 1 below.

R_{L}=Ex₁+Sx₂+Tx₃+Lx₄ Equation 1

Where “R_{L}” is the risk level, “E” is the offset error, “S” is the input duration, “T” is the input time, “L” is the input location, and x₁, x₂, x₃, and x₄ are empirically determined coefficients based on empirical testing of behavioral data from an authorized user providing user inputs. The coefficients x₁, x₂, x₃, and x₄ may, for example, be determined to specify which of the offset error, the input duration, the input time, and the input location corresponds to a higher risk level and which of the offset error, the input duration, the input time, and the input location corresponds to a lower risk level. That is, the coefficients x₁, x₂, x₃, and x₄ may specify respective weights of the offset error, the input duration, the input time, and the input location relative to the risk level.

In Equation 1, “E”, “S,” “T,” and “L” may each be a binary value, e.g., 0 or 1. For example, the vehicle computer 110 can compare the behavioral data from the user providing the invalid user input to stored behavioral data from an authorized user to determine the respective values of “E”, “S,” “T,” and “L” as follows:

| Variable | Value | Explanation |
|---|---|---|
| E (offset error) | 0 | The offset error of the invalid user |
| | | input is within a percentage, e.g., |
| | | 10%, 20%, etc., of the offset error |
| | | specified by the stored behavioral |
| | | data. |
| | 1 | The offset error of the invalid user |
| | | input is not within a percentage, |
| | | e.g., 10%, 20%, etc., of the offset |
| | | error specified by the stored |
| | | behavioral data. |
| S (input duration) | 0 | The input duration of the invalid |
| | | user input is within a percentage, |
| | | e.g., 10%, 20%, etc., of the input |
| | | duration specified by the stored |
| | | behavioral data. |
| | 1 | The input duration of the invalid |
| | | user input is not within a percentage, |
| | | e.g., 10%, 20%, etc., of the input |
| | | duration specified by the stored |
| | | behavioral data. |
| T (input time) | 0 | The input time of the invalid user |
| | | input occurs within a time period, |
| | | e.g., 7am to 7:30am, specified by |
| | | the stored behavioral data. |
| | 1 | The input time of the invalid user |
| | | input does not occur within a time |
| | | period, e.g., 7am to 7:30am, |
| | | specified by the stored behavioral |
| | | data. |
| L (input location) | 0 | The input location of the invalid |
| | | user input occurs at or within a |
| | | distance, e.g., 500 feet, 1 mile, |
| | | etc., of a predetermined location |
| | | specified by the stored behavioral |
| | | data. |
| | 1 | The input location of the invalid |
| | | user input does not occur at or |
| | | within a distance, e.g., 500 feet, |
| | | 1 mile, etc., of a predetermined |
| | | location specified by the stored |
| | | behavioral data. |

As another example, the vehicle computer 110 can determine the risk level based on a message from the master device 140. For example, upon detecting an invalid user input, the vehicle computer 110 can transmit image data, e.g., obtained via an image sensor 115, of the user providing the user input to the master device 140. In this situation, the authorized user, e.g., the vehicle 105 owner, may provide input to the master device 140 indicating an authorization of the user. The master device 140 can then transmit the input to the vehicle computer 110. In the case that the input indicates the user is authorized, then the vehicle computer 110 can determine the risk level is 0. In the case that the input indicates the user is unauthorized, the vehicle computer 110 can determine the risk level is 1.

As another example, the vehicle computer 110 can determine the risk level using a machine learning program such as a convolutional neural network (CNN) programmed to accept behavioral data, e.g., the offset error, the input duration, the input time, and the input location, from the user providing the invalid user input and stored behavioral data from an authorized user as input and output the risk level of the invalid user input. A convolutional neural network (CNN) includes a series of layers, with each layer using the previous layer as input. Each layer contains a plurality of neurons that each receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network may, for example, generate a score for each potential risk level, and the final output is the risk level with the highest score. As another example, the final layer of the convolutional neural network may be a classification vector, i.e., a Softmax layer, that generates and outputs a probability for each potential risk level.

The vehicle computer 110 may be programmed to provide the risk level to a reinforcement learning program. A reinforcement learning program is a form of goal-directed machine learning. For example, an agent, i.e., the vehicle computer 110, can learn from direct interaction with its environment without relying on explicit supervision and/or complete models of the environment. Reinforcement learning is a framework modeling the interaction between a learning agent and its environment in terms of states, actions, and rewards. At each time step, an agent receives a state, selects an action based on a policy, receives a scalar reward, and transitions to the next state. The state can be based on one or more user inputs indicative of the risk level. The agent's goal is to maximize an expected cumulative reward. The agent may receive a positive scalar reward for a positive action and a negative scalar reward for a negative action. Thus, the agent “learns” by attempting to maximize the expected cumulative reward.

The agent can determine the action is a positive action or a negative action based on the output from the vehicle computer 110. For example, the action may be a positive action when the vehicle computer 110 authorizes the user providing the user input to access the vehicle 105 upon receiving a valid user input. As another example, the action may be a positive action when and the vehicle computer 110 verifies the identity of the user, e.g., by analyzing image data (e.g., using image analysis techniques) of the user obtained by one or more sensors 115 on the vehicle 105. An action may, for example, be a negative action when the vehicle computer 110 activates the lockout. As another example, the action may be a negative action and the vehicle computer 110 does not verify the identity of the user. As another example, the action may be a negative action when the vehicle computer 110 denies the user access to the vehicle 105 based on a subsequent invalid user input.

Each scalar reward is a number, typically a scalar value. For example, the positive scalar reward and the negative scalar reward each may be a positive number, i.e., a scalar value greater than 0. Alternatively, the positive scalar reward may be a positive number, and the negative scalar reward may be a negative number, i.e., a scalar value less than 0. The scalar rewards can, for example, be a predetermined value, e.g., programmed into the reinforcement learning program, stored in a memory of the vehicle computer 110 and provided to the reinforcement learning program, etc. As another example, the scalar rewards can be a function of the output risk level from the reinforcement learning program, the risk level, and the output from the vehicle computer 110. For example, the scalar rewards can be determined based on Equation 2 below.

$$R = A ( \frac{{R}_{L} {R}_{o}}{{R}_{o}^{2} + {R}_{L}^{2}} ) \qquad Equation 2$$

Where “R” is the scalar reward, “Rₒ” is the output risk level, “R_{L}” is the risk level, e.g., output from the CNN, and “A” is a number, typically a scalar value, indicating an output from the vehicle computer 110, e.g., the vehicle computer 110 authorized the user to access the vehicle 105, the vehicle computer 110 activated the lockout, the vehicle computer 110 denied access to the vehicle 105 based on a subsequent user input is invalid, an invalid number of user inputs, etc. “A” may have a different value for each output from the vehicle computer 110, e.g., programmed into the reinforcement learning program, stored in a memory of the vehicle computer 110 and provided to the reinforcement learning program, etc.

Based on the scalar rewards, the agent may then adjust the risk level at subsequent time steps. For example, the agent may adjust the risk level to equal the scalar reward received by the agent based on the action. That is, the adjusted risk level may be the received scalar reward. In such an example, the positive scalar reward and the negative scalar reward are each positive numbers. A positive scalar reward may be less than the risk level. That is, based on a positive action (e.g., the vehicle computer 110 authorizing the user to access the vehicle 105), the agent decreases the risk level to equal the positive scalar reward. Additionally, a negative scalar reward may be greater than the risk level. That is, based on a negative action (e.g., the vehicle computer 110 activating the lockout or the vehicle computer 110 denying the user access to the vehicle 105), the agent increases the risk level to equal the negative scalar reward. As another example, the agent may adjust the risk level based on a function of the scalar rewards. In such an example, the agent may decrease the risk level based on receiving a positive scalar reward and may increase the risk level based on receiving a negative scalar reward. For example, the agent may adjust the risk level based on Equation 3 below.

Rₒ₊₁+Rₒ^{R+1}= Equation 3

Wherein “Rₒ₊₁” is the risk level output by the reinforcement learning program at a subsequent time step, e.g., after a subsequent invalid user input. In such an example, “R,” i.e., the scalar reward, may be a positive number, i.e., a scalar value greater than 0, in the case that the agent determines a positive action, and a negative number, i.e., a scalar value less than 0, in the case that the agent determines a negative action.

The vehicle computer 110 compares the risk level to a threshold, e.g., stored in a memory. The threshold may specify a risk level, e.g., 0.7, above which the vehicle computer 110 determines the user input indicates a risk. The threshold may be determined based on empirical test data and/or simulation data of invalid user inputs. The vehicle computer 110 can then adjust the lockout number based on the risk level. In the case that the risk level is above the threshold, the vehicle computer 110 decreases the lockout number. Conversely, in the case that the risk level is below the threshold, the vehicle computer 110 can increase the lockout number.

The vehicle computer 110 may, for example, adjust, i.e., increase or decrease, the lockout number based on a table or the like specifying an amount of increase or decrease, respectively, based on the lockout number, e.g., a predetermined number, e.g., 2, percentage of the lockout number, e.g., 10%, 20%, etc. As another example, the vehicle computer 110 can adjust, i.e., increase or decrease, the lockout number based on a function of the risk level. For example, the vehicle computer 110 can decrease the lockout number based on Equation 4 below and increase the lockout number based on Equation 5 below.

Lₐ=L−(R_{L}x₅) Equation 4

Lₐ=L+(R_{L}x₆) Equation 5

Where “Lₐ” is the adjusted lockout number, “L” is the lockout number, and x₅ and x₆ are empirically determined coefficients based on empirical test data that indicates a number of invalid user inputs provided by authorized users prior to providing a valid user input. For example, x₅ may be determined to reduce Lₐ below the number of invalid user inputs provided by authorized users prior to providing a valid user input. Additionally, x₆ may be determined to increase Lₐ above the number of invalid user inputs provided by authorized users prior to providing a valid user input.

The vehicle computer 110 receives a secondary user input, e.g., via the interface on the vehicle, when the number of invalid user inputs is less than the adjusted lockout number. As used herein, a “secondary user input” is a user input received by the vehicle computer 110 after adjusting the lockout number. The vehicle computer 110 is programmed to determine a validity of the secondary user input, i.e., compare the secondary user input to the identifier string. In the case that the secondary user input is valid, i.e., matches the identifier string, the vehicle computer 110 is programmed to authorize access to the vehicle 105. In the case that the secondary user input is invalid, i.e., does not match the identifier string, the vehicle computer 110 is programmed to deny access to the vehicle 105 and record the invalid user input. Upon the number of invalid user inputs equaling the adjusted lockout number, the vehicle computer 110 is programmed to activate the lockout and to output a message to the master device 140 indicating activation of the lockout.

The vehicle computer 110 may be programmed to authorize access to the vehicle 105 based on an authorization message from the master device 140, e.g., via the network 135. For example, the authorized user, e.g., the vehicle 105 owner, may input the authorization message to the master device 140 based on activation of the lockout. In these circumstances, the master device 140 transmits the authorization message instructing the vehicle computer 110 to authorize access to the vehicle 105 and the identifier of the master device 140 to the vehicle computer 110. That is, the vehicle computer 110 may deactivate the lockout based on receiving the authorization message. The vehicle computer 110 may evaluate the authorization message to determine whether to accept or reject the authorization message, e.g., based on the identifier of the master device 140. For example, the vehicle computer 110 may maintain a list of identifiers that can be authorized. The vehicle computer 110 may require that an identifier be supplied by the master device 140 authorizing access that appears on the list of identifiers that can be authorized and only accept authorization messages from master devices 140 that supply such an identifier.

Additionally, the vehicle computer 110 may be programmed to perform an authentication of the message. Authentication of a digital communication or message as discussed herein means implementing a scheme for determining an authenticity (or lack thereof) of the communication or message, e.g., a message from the master device 140 to the vehicle computer 110 authorizing access to the vehicle 105. Various known techniques such as an authentication signature (or digital signature), an access code, a key (e.g., a combination of numbers and/or characters), etc., may be used for authentication. A valid authentication signature included in a received message may give the vehicle computer 110 a reason to conclude that the message was created by a known sender, e.g., a known master device 140.

The vehicle computer 110 is programmed to store the temporary identifier string, e.g., in a memory. For example, the vehicle computer 110 can receive the temporary identifier string from the server 145 and store the temporary identifier string. That is, the vehicle computer 110 stores the identifier string and the temporary identifier string. By default, the identifier string is active and the temporary identifier string is inactive. In other words, the vehicle computer 110 may deny access to the vehicle 105 based on the user input matching the temporary identifier string. That is, in the case that the temporary identifier string is inactive, the vehicle computer 110 determines a user input that matches the temporary identifier string is invalid.

The vehicle computer 110 may activate the temporary identifier string based on a message from the master device 140. The message may include a request to activate the temporary identifier string and the identifier of the master device 140. For example, the authorized user may specify the request to activate the temporary identifier string, e.g., via an interface on the master device 140. The master device 140 can then transmit the message to the vehicle computer 110. The vehicle computer 110 may evaluate the message to determine whether to accept or reject the message, e.g., based on the identifier of the master device 140 matching an identifier maintained on a list of identifiers that can be authorized. The vehicle computer 110 may require that an identifier be supplied by the master device 140 requesting activation of the temporary identifier string that appears on the list of identifiers that can be authorized and only accept requests to activate the temporary identifier string from master devices 140 that supply such an identifier. Additionally, the vehicle computer 110 may be programmed to perform an authentication of the message requesting to activate the temporary identifier.

Upon accepting the message, the vehicle computer 110 activates the temporary identifier string and deactivates the identifier string. In these circumstances, the vehicle computer 110 determines a user input that matches the identifier string is invalid and a user input that matches the temporary identifier string is valid. The vehicle computer 110 may activate the temporary identifier string for a time period. For example, the time period may be a predetermined time period, e.g., 2 minutes, 5 minutes, etc. As another example, the authorized user, e.g., the vehicle 105 owner, may specify the time period, e.g., via the input to the master device 140. In these circumstances, the master device 140, e.g., in a same or different transmission as the message, may transmit the time period to the vehicle computer 110.

During the time period, the vehicle computer 110 may authorize access to the vehicle 105 based on the user input matching the temporary identifier string (e.g., when the number of invalid user inputs is less than the lockout number). Additionally, the vehicle computer 110 denies access to the vehicle 105 based on the user input not matching the temporary identifier string. In these circumstances, the vehicle computer 110 records an invalid user input. The vehicle computer 110 can then adjust the lockout number, as described above. Upon expiration of the time period, the vehicle computer 110 deactivates the temporary identifier string. In these circumstances the vehicle computer 110 may activate the identifier string. Additionally, or alternatively, the vehicle computer 110 deactivates the temporary identifier string and may activate the identifier string upon authorizing access to the vehicle 105 based on the temporary identifier string.

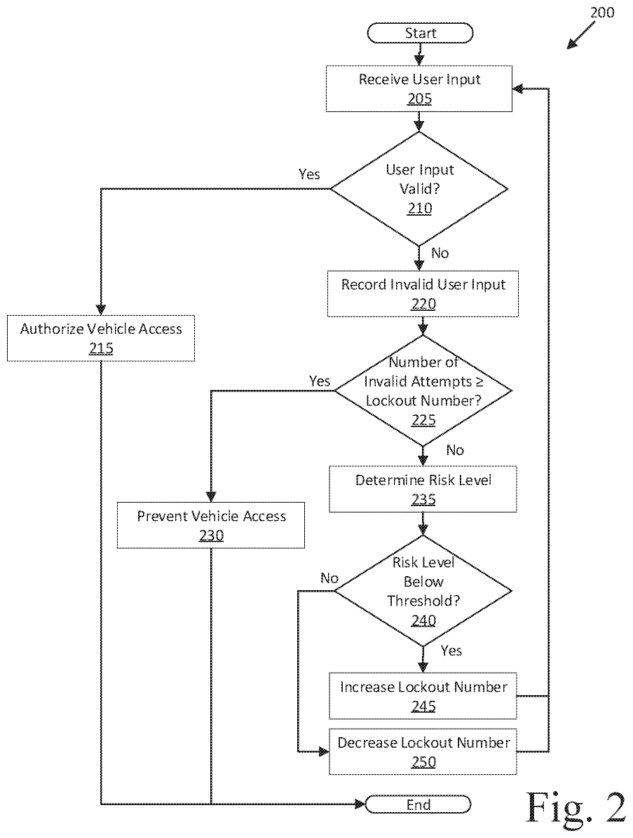

FIG. 2 is a diagram of an example process 200 for authenticating access to a vehicle 105. The process 200 begins in a block 205.

In the block 205, the vehicle computer 110 receives a user input, e.g., via an interface in or on the vehicle 105. For example, a user provides the user input to the interface. The vehicle computer 110 can identify the last character of the user input based on, e.g., the user selecting an “enter” key or the like, a number of characters of the user input equaling a predetermined number, etc. Upon identifying the last character of the user input, the process 200 continues in a block 210.

In the block 210, the vehicle computer 110 determines a validity of the user input. That is, the vehicle computer 110 determines whether the user input is valid or invalid. For example, the vehicle computer 110 is programmed to receive and store, e.g., in a memory, an identifier string (e.g., a PIN). The vehicle computer 110 is programmed to compare the user input to the identifier string. In the case that the user input matches the identifier string (i.e., each character of the user input is the same as the corresponding character of the identifier string), the vehicle computer 110 determines the user input is valid. In the case that the user input does not match the identifier string (i.e., at least one character of the user input is not the same as the corresponding character of the identifier string), the vehicle computer 110 determines the user input is invalid. If the user input is valid, then the process 200 continues in a block 215. Otherwise, the process 200 continues in a block 220.

In the block 215, the vehicle computer 110 authorizes access to the vehicle 105. For example, the vehicle computer 110 may actuate one or more vehicle components 125, e.g., door locks, doors, windows, etc., to allow the user to access the vehicle 105. Additionally, the vehicle computer 110 may authorize the user to operate the vehicle 105. The process 200 ends following the block 215.

In the block 220, the vehicle computer 110 records the invalid user input. Specifically, the vehicle computer 110 counts instance(s) of the invalid user input. For example, the vehicle computer 110 may be programmed to increase, e.g., by one, a number of invalid user inputs stored in a memory upon recording the invalid user input in the block 220. The number of invalid user inputs typically specifies consecutive invalid user inputs. That is, the vehicle computer 110 may reset the number of invalid user inputs to zero upon receiving a valid user input. The process 200 continues in a block 225.

In the block 225, the vehicle computer 110 compares the number of invalid user inputs to the lockout number, e.g., stored in a memory. In the case that the number of invalid user attempts is below the lockout number, the process 200 continues in a block 235. Otherwise, the process 200 continues in a block 230.

In the block 230, the vehicle computer 110 prevents access to the vehicle 105. For example, the vehicle computer 110 may be programmed to activate the lockout. That is, the vehicle computer 110 blocks transmission of additional user inputs and maintains actuation of one or more vehicle components 125, e.g., doors, door locks, etc. Additionally, or alternatively, the vehicle computer 110 may be programmed to transmit a message to the master device 140 indicating activation of the lockout. The message may include image data of the user providing the user input. In such an example, the lockout may be deactivated based on activation of a temporary identifier string, as discussed below. Alternatively, the lockout may be deactivated upon the expiration of a time period, as discussed above. The process 200 ends following the block 230.

In the block 235, the vehicle computer 110 determines a risk level of the invalid user input. For example, the vehicle computer 110 can compare behavioral data from the user providing the invalid user input to stored behavioral data from authorized users. In such an example, the vehicle computer 110 can compare the behavioral data (e.g., the offset error, the input duration, the input time, and the input location) to the stored behavioral data to determine the values of “E,” “S,” “T,” and “L” of Equation 1 above. The vehicle computer 110 can then determine the risk level based on Equation 1.

As another example, the vehicle computer 110 can determine the risk level of the invalid user input based on inputting the behavioral data from the user providing the invalid user input and the stored behavioral data from authorized users into a machine learning program, as discussed above. As yet another example, the vehicle computer 110 can determine the risk level of the invalid user input based on a message from the master device 140, as discussed above. The process 200 continues in a block 240.

In the block 240, the vehicle computer 110 compares the risk level to a predetermined risk threshold stored in a memory of the vehicle computer 110. As discussed above, the threshold is a risk level above which the vehicle computer 110 determines the user input indicates a risk. That is, the vehicle computer 110 can determine the user input does not indicate a risk when the risk level is below the threshold and input indicates a risk when the risk level is above the threshold. In the case that the risk level is below the threshold, the process 200 continues in a block 245. Otherwise, the process 200 continues in a block 250.

In the block 245, the vehicle computer 110 increases the lockout number. For example, the vehicle computer 110 can increase the lockout number based on a table or the like specifying an amount of increase based on the lockout number, e.g., a predetermined number, e.g., 2, or a percentage, e.g., 10%, of the lockout number. As another example, the vehicle computer 110 can increase the lockout number based on a function of the risk level (e.g., Equation 4), as discussed above. The process 200 returns to the block 205.

In the block 250, the vehicle computer 110 reduces the lockout number. For example, the vehicle computer 110 can decrease the lockout number based on a table or the like specifying an amount of decrease based on the lockout number, e.g., a predetermined number, e.g., 4, or a percentage, e.g., 20%, of the lockout number. As another example, the vehicle computer 110 can decrease the lockout number based on a function of the risk level (e.g., Equation 5), as discussed above. The process 200 returns to the block 205.

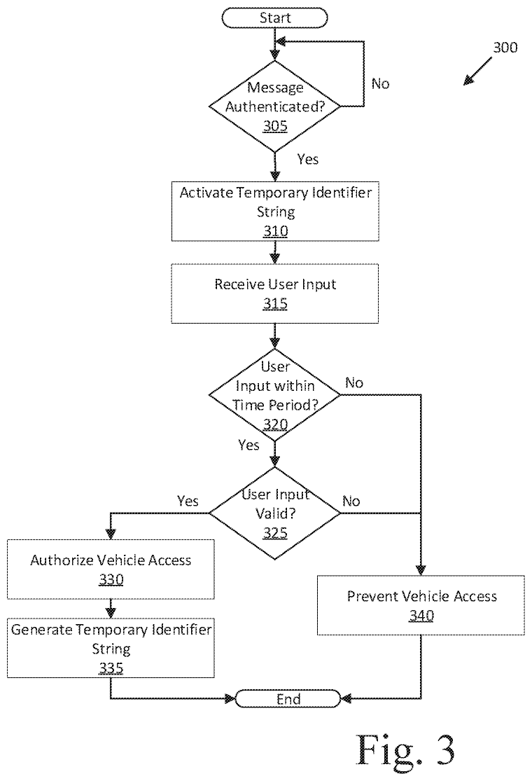

FIG. 3 is a diagram of an example process 300 for activating a temporary identifier string. The process 300 begins in a block 305.

In the block 305, the vehicle computer 110 determines an authorization of a message from the master device 140, e.g., via the network 135. The message may include a request to activate a temporary identifier string, generated as described above, and an identifier of the master device 140. For example, the authorized user may specify the request to activate the temporary identifier string, e.g., via an interface on the master device 140. The vehicle computer 110 may evaluate the message to determine whether to accept or reject the message, e.g., based on the identifier of the master device 140 matching an identifier maintained on a list of identifiers that can be authorized. In the case that the identifier of the master device 140 matches an identifier maintained on the list of identifiers that can be authorized, the process 300 continues in a block 310. Additionally, the vehicle computer 110 can determine an authentication of the message from the master device 140, e.g., based on a digital signature, as discussed above. Otherwise, the process remains in the block 305.

In the block 310, the vehicle computer 110 activates the temporary identifier string. That is, the vehicle computer 110 is programmed to authorize access to the vehicle 105 based on a user input matching the temporary identifier string. Additionally, the vehicle computer 110 deactivates the identifier string. In these circumstances, the vehicle computer 110 is programmed to deny access to the vehicle 105 based on a user input matching the identifier string, i.e., not matching the temporary identifier string. The process 300 continues in a block 315.

In the block 315, the vehicle computer 110 receives a user input, e.g., via an interface on the vehicle 105. For example, a user provides the user input to the interface. The vehicle computer 110 can identify the last character of the user input based on, e.g., the user selecting an “enter” key or the like, a number of characters of the user input equaling a predetermined number, etc. Upon identifying the last character of the user input, the process 300 continues in a block 320.

In the block 320, the vehicle computer 110 determines whether the user input was received within a specified time period. The time period may be predetermined, e.g., stored in a memory, or specified by the authorized user, e.g., via the message from the master device 140. Upon activating the temporary identifier string, the vehicle computer 110 may be programmed to start a timer. In these circumstances, the duration of the timer is the time period. In the case that the user input is received prior to expiration of the timer, the process 300 continues in a block 325. Otherwise the process 300 continues in a block 340.

In the block 325, the vehicle computer 110 determines a validity of the user input, i.e., that the user input is one of valid or invalid. The vehicle computer 110 is programmed to compare the user input to the temporary identifier string. In the case that the user input matches the temporary identifier string, the vehicle computer 110 determines the user input is valid. In the case that the user input does not match the temporary identifier string, the vehicle computer 110 determines the user input is invalid. The vehicle computer 110 then deactivates the temporary identifier string. That is, the vehicle computer 110 determines the validity of one user input when the temporary identifier string is active. If the user input is valid, then the process 300 continues in a block 330. Otherwise, the process 300 continues in a block 340.

In the block 330, the vehicle computer 110 authorizes access to the vehicle 105. For example, the vehicle computer 110 may actuate one or more vehicle components 125, e.g., door locks, doors, windows, etc., to allow the user to access the vehicle 105. Additionally, the vehicle computer 110 may authorize the user to operate the vehicle 105. Additionally, or alternatively, the vehicle computer 110 may be programmed to deactivate the lockout based on the user input being valid. The vehicle computer 110 can then activate the identifier string, i.e., authorize access to the vehicle 105 based on a user input matching the identifier string, or request the user to provide a new identifier string, e.g., via the master device 140. The process 300 continues in a block 335.

In the block 335, the server 145 may be programmed to generate a new temporary identifier string. For example, the vehicle computer 110 can transmit a message to the server 145 upon authorizing access to the vehicle 105 based on the user input matching the temporary identifier string. Upon receipt of the message, the server 145 can generate a new temporary identifier string, as discussed above. The server 145 can then transmit the new temporary identifier string to the vehicle computer 110. The vehicle computer 110 can then store the new temporary identifier string in a memory. The process 300 ends following the block 335.

In the block 340, the vehicle computer 110 prevents access to the vehicle 105. For example, the vehicle computer 110 may be programmed to activate the lockout. That is, the vehicle computer 110 blocks transmission of additional user inputs and maintains actuation of one or more vehicle components 125, e.g., doors, door locks, etc. Additionally, or alternatively, the vehicle computer 110 may be programmed to transmit a message to the master device 140 indicating activation of the lockout. The message may include image data of the user providing the user input. The process 300 ends following the block 340.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
determine a validity of a user input by determining the user input (a) matches an identifier string and is valid or (b) does not match the identifier string and is invalid;
authorize access to a vehicle based on the user input being valid;
determine a number of invalid attempts based on the user input being invalid;
based on the number of invalid attempts being less than a lockout number, evaluate a risk level of the user input to adjust the lockout number; and
then, upon determining the validity of a secondary user input, (a) authorize access to the vehicle based on the secondary user input being valid or (b) activate a lockout of the vehicle based on the secondary user input being invalid and the number of invalid attempts equaling the adjusted lockout number.

2. The system of claim 1, wherein the instructions further include instructions to decrease the lockout number based on the risk level being above a threshold.

3. The system of claim 1, wherein the instructions further include instructions to increase the lockout number based on the risk level being below a threshold.

4. The system of claim 1, wherein the instructions further include instructions to determine the risk level based on comparing behavioral data from the user providing the invalid user input to stored behavioral data, behavioral data includes at least one of an offset error, an entry speed, an entry time, and a location of the vehicle.

5. The system of claim 1, wherein evaluating the risk level includes obtaining the risk level as output from a machine learning program.

6. The system of claim 5, wherein behavioral data from the user providing the invalid user input and the stored behavioral data are input into the machine learning program, behavioral data includes at least one of an offset error, an entry speed, an entry time, and a location of the vehicle.

7. The system of claim 1, wherein the instructions further include instructions to output a message to a master device upon the number of invalid attempts equaling the adjusted lockout number.

8. The system of claim 1, wherein the instructions further include instructions to authorize access to the vehicle based on a message from a master device.

9. The system of claim 1, wherein the instructions further include instructions to deactivate the lockout based on a message from a master device.

10. The system of claim 1, wherein the instructions further include instructions to receive a temporary identifier string from a server, wherein the server is programmed to generate the temporary identifier string and transmit the temporary identifier string to the computer.

11. The system of claim 9, wherein the instructions further include instructions to, upon activation of the temporary identifier string, authorize access to the vehicle based on the user input matching the temporary identifier string.

12. The system of claim 10, wherein the instructions further include instructions to activate the temporary identifier string based on a message from a master device.

13. The system of claim 10, wherein the instructions further include instructions to activate the temporary identifier string for a time period.

14. The system of claim 9, wherein the instructions further include instructions to, upon activation of the temporary identifier string, deactivate the lockout based on the user input matching the temporary identifier string.

15. A method comprising:
determining a validity of an entry to an interface by determining the entry (a) matches an identifier string and is valid or (b) does not match the identifier string and is invalid;
authorizing access to a vehicle based on the user input being valid;
determining a number of invalid attempts based on the user input being invalid;
based on the number of invalid attempts being less than a lockout number,
evaluating a risk level of the user input to adjust the lockout number; and
then, upon determining the validity of a secondary user input, (a) authorizing access to the vehicle based on the secondary user input being valid or (b) activating a lockout of the vehicle based on the secondary user input being invalid and the number of invalid attempts equaling the adjusted lockout number.

16. The method of claim 15, further comprising decreasing the lockout number based on the risk level being above a threshold and increasing the lockout number based on the risk level being below the threshold.

17. The method of claim 15, further comprising determining the risk level based on comparing behavioral data from the user providing the invalid user input to stored behavioral data, behavioral data includes at least one of an offset error, an entry speed, an entry time, and a location of the vehicle.

18. The method of claim 15, further comprising outputting a message to a master device computer upon the number of invalid attempts equaling the adjusted lockout number.

19. The method of claim 15, wherein evaluating the risk level includes obtaining the risk level as output from a machine learning program.

20. The method of claim 19, wherein behavioral data from the user providing the invalid user input and the stored behavioral data are input into the machine learning program, behavioral data includes at least one of an offset error, an entry speed, an entry time, and a location of the vehicle.
